(19) United States
(12) Patent Application Publication
(10) Pub. No.: US 2006/0155651 A1
(43) Pub. Date: Jul. 13, 2006

(54) Device and method for digital rights management

(75) Inventors: Yun-sang Oh, Seoul (KR); Kyung-im Jung, Seongnam-si (KR); Sang-gyoo Sim, Seoul (KR); Suk-bong Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/331,266

(22) Filed: Jan. 13, 2006

Related U.S. Application Data
(60) Provisional application No. 60/643,150, filed on Jan. 13, 2005.

(30) Foreign Application Priority Data
Nov. 23, 2005 (KR) 10-2005-0112554

(51) Int. Cl. G06Q 99/00

(52) U.S. Cl. 705/57

(57) ABSTRACT

A digital rights management (DRM) device and method are provided. The DRM device includes a storage module which stores a rights object (RO) having predetermined meta information, a control module which provides meta information of ROs stored in the storage module when an RO detection request is input, and an integrity check module which maintains integrity of the meta information.

### CROSS-REFERENCE TO RELATED APPLICATIONS

This application claims priority from Korean Patent Application No. 10-2005-0112554 filed on Nov. 23, 2005 in the Korean Intellectual Property Office, and U.S. Provisional Patent Application No. 60/643,150 filed on Jan. 13, 2005 in the United States Patent and Trademark Office, the disclosures of which are incorporated herein by reference in their entirety.

### BACKGROUND OF THE INVENTION

1. Field of the Invention

Apparatuses and methods consistent with the present invention relate to digital rights management, and more particularly, to digital rights management, by which information regarding rights object can be efficiently managed.

2. Description of the Related Art

Recently, digital rights management (hereafter, referred to as DRM) has been actively researched and developed. Commercial services using DRM have already been used or will be used. DRM needs to be used because of various characteristics of digital content, such as the ability to copy and easily distribute digital content.

There have been several efforts to protect digital content. Conventionally, digital content protection has been concentrated on preventing non-permitted access to digital content, permitting only people who has paid charges to access the digital content. Thus, people who paid charges to the digital content are allowed to unencrypted digital content while people who did not pay charges are not allowed to. In this case, when a person who has paid charges intentionally distributes the digital content to other people, however, those other people can use the digital content without paying charges.

To solve this problem, DRM was introduced. In DRM, anyone is allowed to freely access encoded digital content, but a license referred to as a rights object is needed to decode and execute the digital content.

Referring to FIG. 1, a device 10 obtains a digital content from a content provider 20. Here, the digital content provided by the content provider 20 is in an encrypted format. To play the encrypted digital content, a rights object (RO) is necessary.

The device 10 can obtain the RO with a license to play the encrypted content received from an RO issuer 30. To this end, a user should pay charges. The encrypted digital content is decrypted using a key contained in the RO.

The RO issuer 30 makes the content provider 20 prepare a rights object issuing detail report. The RO issuer 30 and the content provider 20 may be the same authorities.

After obtaining the RO, the device 10 consumes the RO to use the encrypted digital content.

The encrypted digital content can be freely copied and distributed to another device (not shown). However, since an RO contains constraint information such as Count, Interval or Copy, unlike the encrypted digital content, the RO has a limitation in its reuse or replication. Accordingly, the digital content can be more effectively protected by using DRM.

A device storing ROs, which are quite important in DRM, should safely protect the ROs from external devices attempting to access the same. Conventionally, on the one hand, ROs are protected in a hardware manner by storing the ROs in predetermined secure storage regions of the device. On the other hand, ROs are protected in a software manner by storing the ROs in encrypted states using various encryption algorithms.

However, such encryption based protection technique may result in a reduced device memory speed in read and write operations. For example, when a user intends to search for information for ROs stored in a device, the device needs to decrypt encrypted ROs, extract information from the decrypted ROs and then display the extracted information, resulting in a slow response to a user's request, which is particularly alleviated when the ROs are stored in a portable storage device having an operation capability lower than a normal device that can play back a content object.

### SUMMARY OF THE INVENTION

The present invention provides a method of effectively searching for information regarding rights objects.

The above stated aspect as well as other aspects, features and advantages, of the present invention will become clear to those skilled in the art upon review of the following description, the attached drawings and appended claims.

According to an aspect of the present invention, there is provided a digital rights management (DRM) device including a storage module which stores a rights object (RO) having predetermined meta information, a control module which provides meta information of ROs stored in the storage module when an RO detection request is input, and an integrity check module which maintains integrity of the meta information.

According to another aspect of the present invention, there is provided a digital rights management (DRM) method including: providing meta information of rights objects (ROs) stored in a predetermined storage medium when an RO detection request is input, and maintaining integrity of the meta information.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram of conventional digital rights management (DRM);

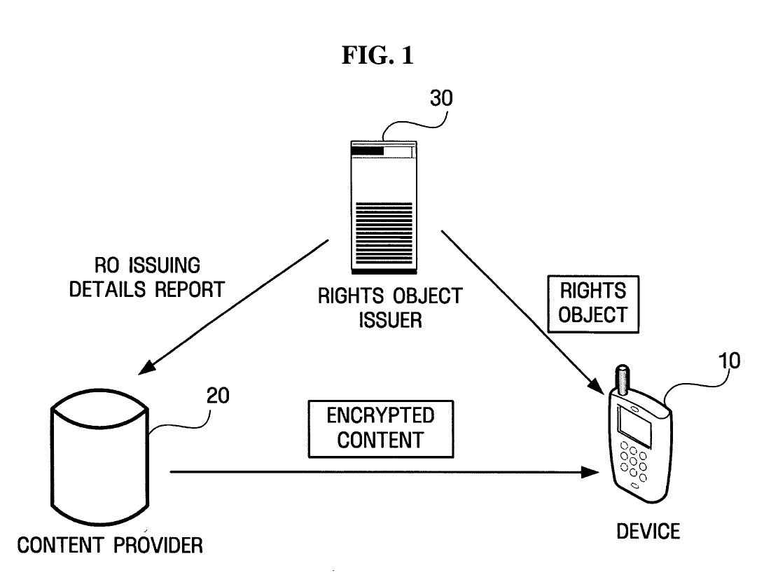

FIG. 2 is a block diagram of a DRM device according to an exemplary embodiment of the present invention;

FIG. 3 is a flowchart illustrating a digital rights management method according to an exemplary embodiment of the present invention;

FIG. 4 is a flowchart illustrating a procedure in which integrity of meta information is maintained according to an exemplary embodiment of the present invention;

FIG. 5 is a block diagram of a host device according to an exemplary embodiment of the present invention;

FIG. 6 is a diagram illustrating a DRM system according to an exemplary embodiment of the present invention;

FIG. 7 is a block diagram of a portable storage device according to an exemplary embodiment of the present invention;

FIG. 8 is a flowchart illustrating an authentication procedure according to an exemplary embodiment of the present invention;

FIG. 9 is a flowchart illustrating a detection procedure, in which a host device detects a rights object stored in the portable storage device, according to an exemplary embodiment of the present invention.

### DETAILED DESCRIPTION OF EXEMPLARY EMBODIMENTS OF THE INVENTION

Aspects of the present invention may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in detail with reference to the attached drawings.

Before the detailed description is set forth, terms used in this specification will be described briefly. Description of terms is to be construed as being provided for a better understanding of the specification and terms that are not explicitly defined herein are not intended to limit the broad aspect of the invention.

Host Device

A host device is connectable to a portable storage device and enables execution of encrypted content. Exemplary host devices are portable multimedia devices such as mobile phones, PDAs or MP3 players, desk-top computers, or digital TVs, and so on.

Portable Storage Device

A portable storage device used in exemplary embodiments of the present invention includes a non-volatile memory such as a flash memory which data can be written to, read from, and deleted from and which can be connected to a device. Examples of such portable storage device are smart media, memory sticks, compact flash (CF) cards, xD cards, and MMCs.

Content Object

A content object is a digital content in an encrypted state. Here, examples of the digital content include, but is not limited to, a moving picture, a still picture, a game, a text, and so on.

Rights Object

A rights object is a type of a license to use an encrypted content object. The rights object may include a content encryption key, permission information, constraint information, status information, and a content object identifier which can identify a content object to be played using a content encryption key.

Content Encryption Key

A content encryption key may have a binary value in a predetermined format. For example, the content encryption key can be used in acquiring original content by decrypting a content object.

Permission Information

Permission information indicates play-back and reproduction types of a content object.

Example of the play back include “Play”, “Display”, “Execute”, and “Print”. The Play component indicates a right to express content in an audio/video format. In addition, the Display component indicates a right to display a content object through a visual device, and the Print component indicates a right to generate a hard copy of a content object. For example, in a case where the content object is a moving picture or music, at least one of the display component and print component may be set as permission information of a rights object to be consumed to play the content object. The Execute component indicates a right to execute a content object such as games and other application programs. For example, in a case where the content object is a JAVA game, the Execute component may be set as permission information of a rights object to be consumed to play the JAVA game.

Meanwhile, examples of the duplication include the Copy component and the Move component. The copy component and the move component are rights to move a rights object from one device to another device and to store the same. The Move component deactivates the original rights object in the current device, while the Copy component does not deactivate the original rights object in the current device. Here, deactivation may mean deletion of a rights object.

Constraint Information

Constraint information refers to constraints on allowing a rights object (RO) to be played back and one or more pieces of constraint information may be set. Examples of the constraint information may include count constraint, datetime constraint, interval constraint, accumulated constraint, and so on.

Here, the count constraint specifies the count of permissions granted to a content object. When the count constraint is set to 10, the host device is allowed to play the content object 10 times until the count constraint for the rights object is consumed.

The Datetime constraint specifies duration for permission and selectively contains a start element or an end element. When a rights object with a datetime constraint set is consumed, the host device can play a content object after and before a time/date specified by a start item of the datetime constraint. For example, when the start item is set to 00:00:00 (hour:minute:second) 2005-12-01 (year-month-day), the host device cannot have access to and consume the RO for playing the content object before 00:00:00 2005-12-01.

An Interval constraint specifies a time interval at which an RO can be executed for the corresponding content object. When a start element is contained in the Interval constraint, consumption of the content object is permitted during a period of time specified by a duration element contained in the Interval constraint after a specified time/date. For example, for an interval constraint of one week, when the host device consumes an RO on and after 00:00:00 2005-12-01 to play a content object, consumption of the RO for playing the content object is permitted until 00:00:00 2005-12-08.

An Accumulated constraint specifies a maximum time interval for an accumulated measured period of time while the rights object is executed for the corresponding content object. When a rights object has the accumulated constraint set to 10, the host device can have the rights object to play a content object for 10 hours. In this instance, the host device is not limited by the Count or Datetime.

Status Information

A rights object can be consumed within a range that the constraint information permits. The status information indicates whether a rights object (RO) is usable or not on the basis of the constraint information conditions. The status information of each RO includes a valid state in which the RO is usable, an invalid state in which the RO is unusable, and an unidentified state in which usability of the RO is not identifiable. Here, the unidentified state is set when the usability of the RO may be varied over time. For example, when the Datetime or the Interval is specified, usability of an RO cannot be known by constraint information only. That is, at the time of identifying status information, time information may be additionally required. In such a case, the status information of each RO having the Datetime or the Interval may be set to an unidentified state.

Meta Information

Meta information is referred to as predetermined meta data for a rights object and includes at least one of permission information, constraint information, and status information.

Public-Key Cryptography

This is also referred to as asymmetric cryptography because encryption is made when a key used in decrypting data and a key used in encrypting the data constitute different encryption keys. In public-key cryptography, an encryption key consists of a pair of a public key and a private key. The public key is not necessary to be kept in secret, i.e., the public is easily accessible thereto while the private key must be known only to a specific device. This public key encryption algorithm has been disclosed to the general public but a third person cannot know or hardly knows the original content with encryption algorithm, encryption key and ciphered text. There are examples of public key encryption algorithms such as Diffie-Hellman, RSA, El Gamal, Elliptic Curve, etc.

Symmetric-Key Cryptography

This is also referred to as secret key cryptography, wherein encryption is made when a key used to encrypt data and a key used to decrypt the data constitute the same encryption key. As an example of such symmetric key encryption, data encryption standard (DES) method is used most generally, but application adopting advanced encryption standard (AES) method has recently been increased.

Random Number

A random number is a sequence of numbers or characters with random properties. Since it costs a lot to generate a complete random number, a pseudo-random number may be used.

Module

A module means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed on one or more CPUs in a communication system.

Terms specifically defined above will be described below when necessary.

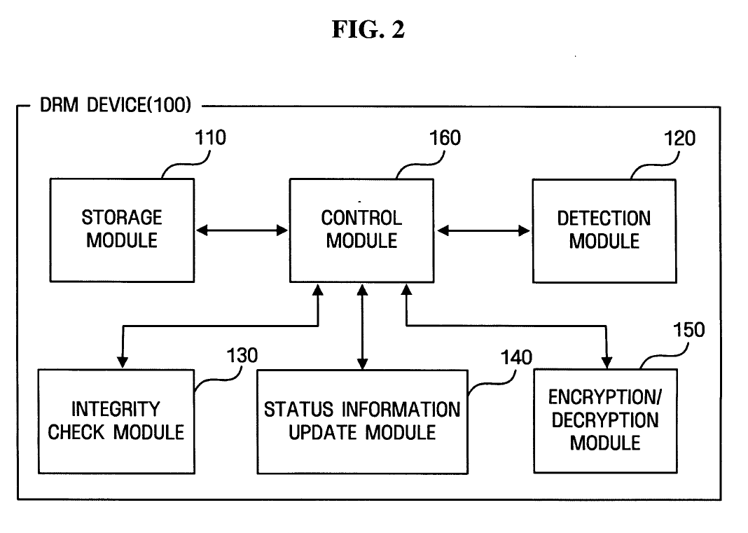

FIG. 2 is a block diagram of a digital rights management (DRM) device 100 according to an exemplary embodiment of the present invention. The DRM device 100 includes a storage module 110, a detection module 120, an integrity check module 130, a status information update module 140, an encryption/decryption module 150, and a control module 160.

The storage module 110 includes a storage medium such as a flash memory, and is divided into a secured storage region and a normal storage region. In the secured storage region are stored secure data necessary to be protected from being accessed by an external device (not shown) or an external module (not shown), such as ROs, hash values for meta information of ROs, and predetermined encryption keys. In the normal storage region is stored non-secure data such as a content object, which is open to free accessing.

Each RO stored in the storage module 110 may include meta information. The meta information may be included in a fixed field in each RO. For example, it may be prescribed that meta information is written on a field corresponding to the a-th through n-th bits. In this case, irrespective of the type of RO, meta information of each RO can be obtained from a fixed field of the RO.

The detection module 120 detects the meta information of each RO stored in the storage module 110 according to a request from the RO. The request from the RO may be applied from the external device or the external module.

The integrity check module 130 maintains the integrity of meta information. That is to say, the integrity check module 130 can prevent the meta information from being changed by checking the integrity of the meta information, e.g., the external device's or the external module's access to the meta information. For example, the integrity check module 130 calculates a hash value for meta information accessed by an external device or an external module using a predetermined hash function and compares the calculated hash value with a hash value stored in the storage module 110. If the two hash values are the same, it is determined that the integrity of meta information is maintained. Here, the hash value stored in the storage module 110 may be one calculated for meta information of each RO when the RO is stored in the storage module 110. Accordingly, the meta information may be open to external devices or external modules but cannot be changed.

In addition, when status information contained in arbitrary meta information is changed by the status information update module 140, the integrity check module 130 calculates a hash value for the meta information having the changed status information and stores the calculated hash value in the storage module 110. Accordingly, the hash value in the storage module 110 is updated with the newly calculated hash value.

When the status information contained in the meta information detected by the detection module 120 is set to an unidentified state, the status information update module 140 compares time information at a time of detecting meta information with constraint information included in the meta information, thereby determining whether the RO is usable or not. For example, when the end element of the Interval constraint is set to 00:00:00 2005-11-01, and time information at a meta information detection time specifies 00:00:00 2005-11-02, the RO is determined as being in a unusable state. The time information at a meta information detection time can be obtained from an external device or an external module.

As the determination result, if the RO is determined to be usable, the status information update module 140 maintains the status information included in the meta information in an unidentified state. However, if the RO is maintained as being in an unusable state, the status information update module 140 changes the status information included in the meta information to an invalid state.

In addition, when the valid ROs are used up and no more ROs are available, the status information update module 140 changes the status information included in the meta information to an invalid state.

The encryption/decryption module 150 performs encryption and decryption on predetermined data. That is, upon request of the control module 160, the encryption/decryption module 150 encrypts the data to be transmitted to an external device or an external module or decrypts the encrypted data received from the external device or the external module. The encryption/decryption module 150 may perform public key encryption or private key encryption. One or more encryption/decryption modules for performing both encryption types may exist.

Alternatively, the encryption/decryption module 150 may generate a predetermined random number required during authentication with the external device or the external module. Meanwhile, each RO stored in the storage module 110 may have a portion other than meta information, the portion being encrypted by the encryption/decryption module 150 using unique encryption keys included in the DRM device 100. In an exemplary embodiment, the encrypted portion of the RO may be a content encryption key. Thus, in a case where the RO should be supplied to the external device or the external module, the encryption/decryption module 150 decrypts the encrypted portion of the RO and then encrypts the RO in such a manner that the authenticated external device or the external module can decrypt the RO.

The control module 160 controls operations of various modules 110 through 150 constituting the DRM device 100. Thus, the control module 160 serves as a DRM agent controlling an overall DRM procedure of the DRM device 100. In addition, the control module 160 can control the authentication relative to the external device or the external module.

Meanwhile, the control module 160 offers meta information detected by the detection module 120 to the external device or the external module. In the present invention, “offering the meta information” means not only “actively transmitting the meta information to the external device or the external module that has requested for the meta information” but also “granting the external device or the external module to access the meta information”.

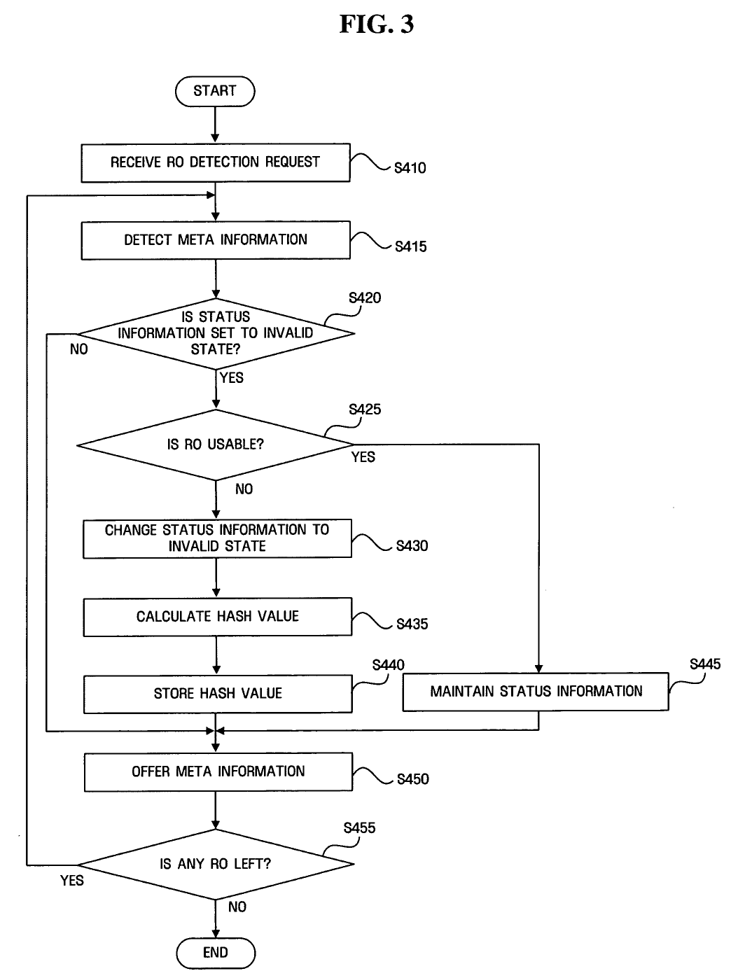

An operating procedure of the DRM device 100 will now be described with reference to FIG. 3.

FIG. 3 is a flowchart illustrating a digital rights management method according to an exemplary embodiment of the present invention.

In operation S410, when an RO detection request is input from an external device or an external module, the detection module 120 detects meta information stored in ROs stored in the storage module 110 in operation S415.

If the meta information contains status information, the status information update module 140 determines whether the status information is set to an invalid state in operation S420.

As a result, if it is determined in operation S420 that the status information is not in an invalid state, that is, in a valid state or an invalid state, the control module 160 offers the detected status information to the external device or the external module in operation S450.

If it is determined in operation S420 that the status information is in an invalid state, the status information update module 140 compares the time information at a time of detecting meta information with constraint information included in the meta information and determines as to usability of the RO including the meta information in operation S425.

If it is determined that the RO is usable in operation S425, the status information update module 140 maintains the status information at an unidentified state in operation S445. In operation S450, the control module 160 offers the meta information to the external device or the external module.

On the other hand, if it is determined that the RO is unusable in operation S425, the status information update module 140 changes the status information to an invalid state in operation S430. Here, the integrity check module 130 calculates a hash value for the meta information with the status information changed using a predetermined hash function in operation S435. Then, the integrity check module 130 stores the calculated hash value S440 in the storage module 110. That is to say, the integrity check module 130 updates the hash value stored in the storage module 110 with the one calculated for meta information of each RO in operation S435. Thereafter, the control module 160 supplies the meta information including changed status information to the external device or the external module.

If it is determined in operation S455 that ROs are left in the storage module 110, the procedure goes back to operation S415 so that the detection module 120 detects meta information for the ROs left in the storage module 110.

The above-described processes may be repeated until the meta information for all the ROs stored in the storage module 110 is completely detected.

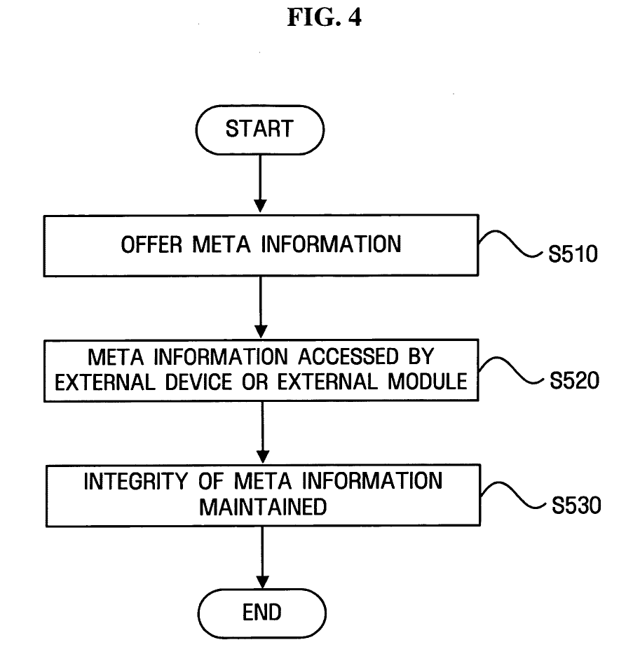

During the procedure shown in FIG. 3, the integrity check module 130 prevents the meta information from being changed by the external device or the external module, which is shown in FIG. 4.

In operation S510, the control module 160 supplies the meta information. When the external device or the external module accesses the meta information in operation S520, the integrity check module 130 maintains integrity of the meta information accessed by the external device or the external module in operation S530. For example, the integrity check module 130 calculates a hash value for the meta information accessed by the external device or the external module using a predetermined hash function and makes the calculated hash value equalize with a hash value stored in the storage module 110, thereby preventing unauthorized change of the meta information.

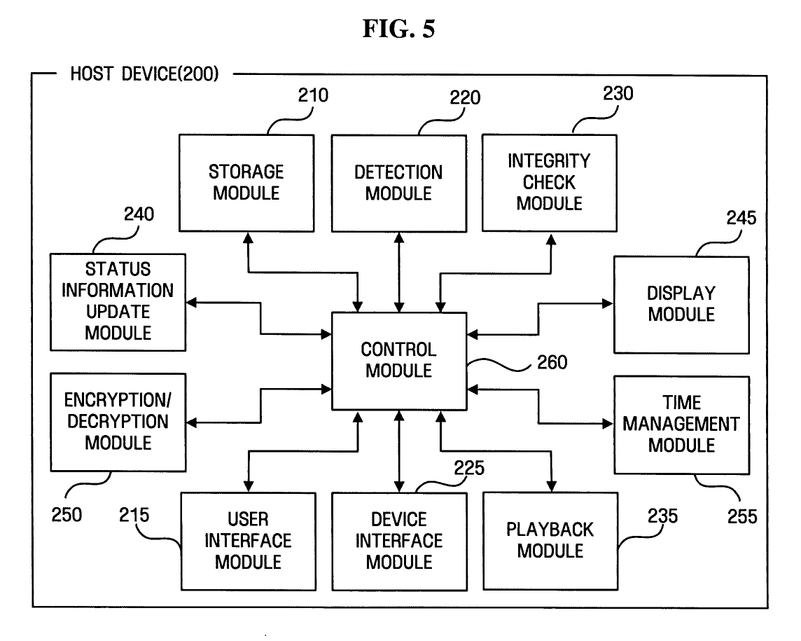

The DRM device 100 having been described with reference to FIGS. 2 through 4 can be implemented by a wide variety of types of devices. For example, the DRM device 100 may be a host device, which is shown in FIG. 5.

FIG. 5 is a block diagram of a host device 200 according to an exemplary embodiment of the present invention.

The host device 200 includes the DRM device 100. That is to say, a storage module 210, a detection module 220, an integrity check module 230, a status information update module 240, an encryption/decryption module 250 and a control module 260 of the host device 200 perform the same functions of the storage module 110, the detection module 120, the integrity check module 130, the status information update module 140, the encryption/decryption module 150, and the control module 160 of the DRM device 100, respectively, and their repetitive description will be omitted.

The host device 200 further includes a user input module 215, a device interface module 225, a playback module 235, a display module 245, and a time management module 255.

The user input module 215 receives a predetermined command or a request from a user. To this end, the user input module 215 may include input means such as a keypad, a touch pad or a touch screen. Thus, the user may submit at an input of user input module 215 for a request for detection of ROs stored in the storage module 210. When the request for detection of ROs is input, the procedure shown in FIGS. 3 and 4 can be performed.

The device interface module 225 transmits/receives data to/from an external device (e.g., a portable storage device). Thus, the host device 200 can be connected with the external device through the device interface module 225.

The playback module 235 reproduces a content object using an RO. For example, the playback module 235 may be an MPEG decoding module that can reproduce a moving picture.

The display module 245 displays the content object reproduced by the playback module 235 or meta information supplied from the control module 260 so that the user can visually see it as used (for example, through playing or executing the content, etc.). The display module 245 may be constructed with a liquid crystal display panel such as PDP, LCD or an organic EL.

The time management module 255 manages current time information.

A detection procedure in which the host device 200 having the above-described structure detects ROs stored therein will be understood from the description made with reference to FIGS. 3 and 4.

As described above with reference to FIG. 3, specifically in operation S425, the time information necessary for determining usability of an unidentified RO may be supplied from the time management module 255. The meta information supplied in operation S450 shown in FIG. 3 can be displayed through the display module 245.

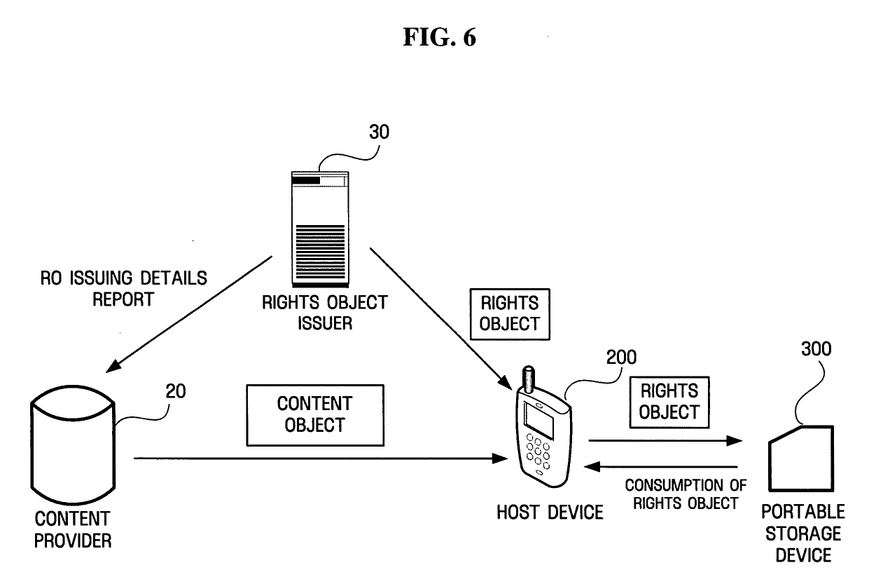

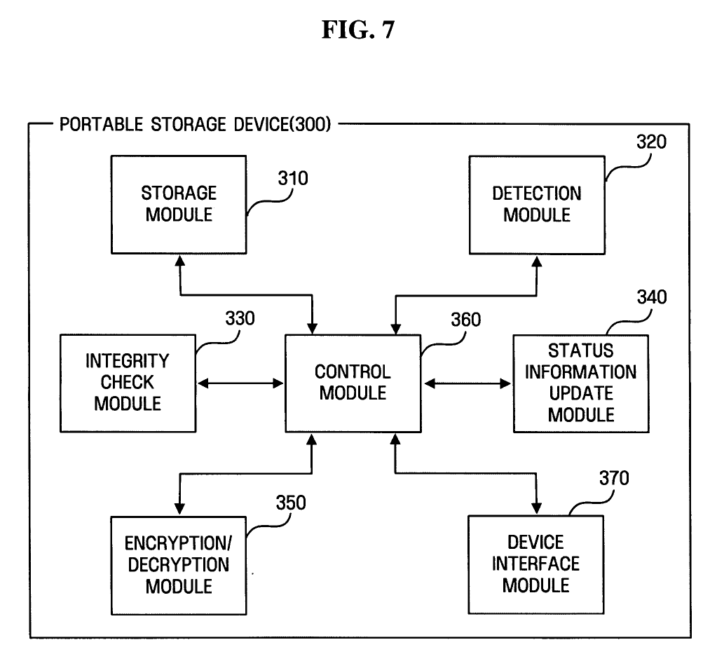

In another exemplary embodiment, the user may store ROs in a portable storage device other than the host device 200, or may consume or detect ROs stored in a portable storage device using the host device 200. Here, the DRM device 100 having been described with reference to FIG. 2 can be implemented by a portable storage device. A DRM system using a portable storage device will first be described with reference to FIG. 6 and a structure of the portable storage device will then be described with reference to FIG. 7.

FIG. 6 is a block diagram of the DRM system 100 according to an exemplary embodiment of the present invention. The DRM system includes a host device 200 and a portable storage device 300.

Like in the conventional art, a user can obtain a content object from a content provider 20 or can pay an RO issuer 30 to purchase an RO for an encrypted content. The purchased RO may be stored in the host device 200 or transferred (moved or copied) to the portable storage device 300. In addition, the portable storage device 300 may store one or more ROs at its production time.

In a case where the portable storage device 300 stores ROs, after the host device 200 is connected with the portable storage device 300, the host device 200 consumes ROs stored in the portable storage device 300 to play the same. In this case, the host device 200 may have the same structure as and perform the same function as described with reference to FIG. 5.

FIG. 7 is a block diagram of the portable storage device 300 according to an exemplary embodiment of the present invention.

The portable storage device 300 includes the DRM device 100. That is to say, a storage module 310, a detection module 320, an integrity check module 330, a status information update module 340, an encryption/decryption module 350 and a control module 360 of the portable storage device 300 perform the same functions of the storage module 110, the detection module 120, the integrity check module 130, the status information update module 140, the encryption/decryption module 150, and the control module 160 of the DRM device 100, respectively, and their repetitive description will be omitted. The portable storage device 300 may further include a device interface module 370.

The device interface module 370 transmits/receives data to/from an external device (e.g., the host device 200). Thus, the portable storage device 300 can be connected with the external device through the device interface module 370.

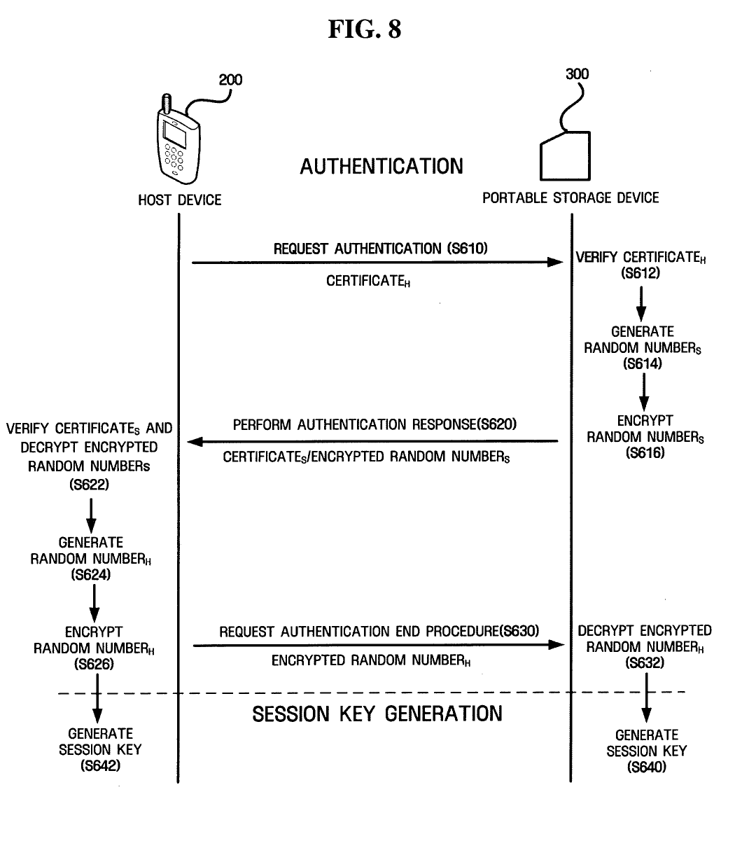

When the host device 200 is connected with the portable storage device 300 to detect ROs stored in the portable storage device 300, authentication may be performed on the host device 200 and the portable storage device 300. Authentication is a fundamental procedure in which the host device and the portable storage device authenticate each other's genuineness, thereby maintaining security of data exchanged therebetween, which will be described with reference to FIG. 8.

FIG. 8 is a flowchart illustrating an authentication procedure according to an exemplary embodiment of the present invention.

In the exemplary embodiment, a subscript “H” of data indicates that the data is possessed or generated by a host device 200 and a subscript “S” of data indicates that the data is possessed or generated by a portable storage device 300.

In operation S610, the host device 200 sends an authentication request to the portable storage device 300. When requesting authentication, the host device 200 may send the portable storage device 300 a certificate_{H}, which was issued to the host device 200 by a certification authority. The certificate_{H} is signed with a digital signature of the certification authority and contains a device ID_{H} and the public key_{H}. In addition, when the host device 200 is connected with the portable storage device 300 in the present invention, the host device 200 and the portable storage device 300 are electrically connected with each other via each wired medium. However, this is just an example, and “being connected” may also imply that two devices can communicate with each other through a wireless medium in a non-contact state.

In operation S612, the portable storage device 300 verifies whether the certificate_{H} of the host device 200 is valid using a certificate revocation list (CRL). If the certificates is registered in the CRL, the portable storage device 300 may reject the authentication with the host device 200. If the certificate_{H} is not registered in the CRL, the portable storage device 300 obtains the public key_{H} using the certificate_{H} of the host device 200.

If it is determined that the host device 200 is verified as an authenticated device, that is, the certificate_{H} of the host device 200 is valid, in operation S614, the portable storage device 300 generates a random number_{S}. In operation S616, the generated random number_{S} is encrypted using the public key_{H}.

In operation S620, the portable storage device 300 performs an authentication response procedure. During the authentication procedure, the portable storage device 300 sends a certificate_{S}, which was issued to the portable storage device 300 by the certification authority, and the encrypted random numbers. The certificate_{S} is signed with a digital signature of the certification authority and contains an ID_{H} and public key_{H} of the portable storage device 300.

In operation S622, the host device 200 receives the certificate_{S} and encrypted random number_{S} and authenticates the portable storage device 300 by verifying the certificate_{S}, and decrypts the encrypted random number_{S} using its own private key_{H}. Here, the host device 200 obtains the public key_{S} of the portable storage device 300 using the certificate_{S} of the portable storage device 300. In addition, verification of the certificate_{S} may also be performed on the portable storage device 300 using CRL.

If the portable storage device 300 is verified as an authenticated device using the certificate_{S} of the portable storage device 300, in operation S624, the host device 200 generates a random number_{H}. In operation S626, the generated random number_{H} is encrypted using the public key_{S} of the portable storage device 300.

Thereafter, the host device 200 requests the portable storage device 300 for an authentication end procedure in operation S630. When requesting for the authentication end procedure, the host device 200 sends the encrypted random number_{H} to the portable storage device 300.

In operation 632, the portable storage device 300 receives the encrypted random number_{H} and decrypts the random number_{H} using its private key_{S}.

Accordingly, the host device 200 and the portable storage device 300 share each other's random numbers, that is, random number_{H} and random number_{S}.

As a result, the host device 200 and the portable storage device 300 sharing each other's random numbers generate their session keys in operations S640 and S642. Here, in order for the host device 200 and the portable storage device 300 to generate their session keys, the same algorithm may be used. Therefore, the host device 200 and the portable storage device 300 share the same session key.

After authentication is completed, encrypting and decrypting the data to be transmitted between the host device 200 and the portable storage device 300 using their session keys can further provide for ensured security in data transmission. In several exemplary embodiments that are described follow, unless otherwise noted, it is to be understood that the host device 200 and the portable storage device 300 encrypt and decrypt the data to be transmitted to each other using each session key generated by the authentication.

After completing the authentication procedure, the host device 200 may move or copy an RO to the portable storage device 300 or may consume an RO stored in the portable storage device 300 to play the RO.

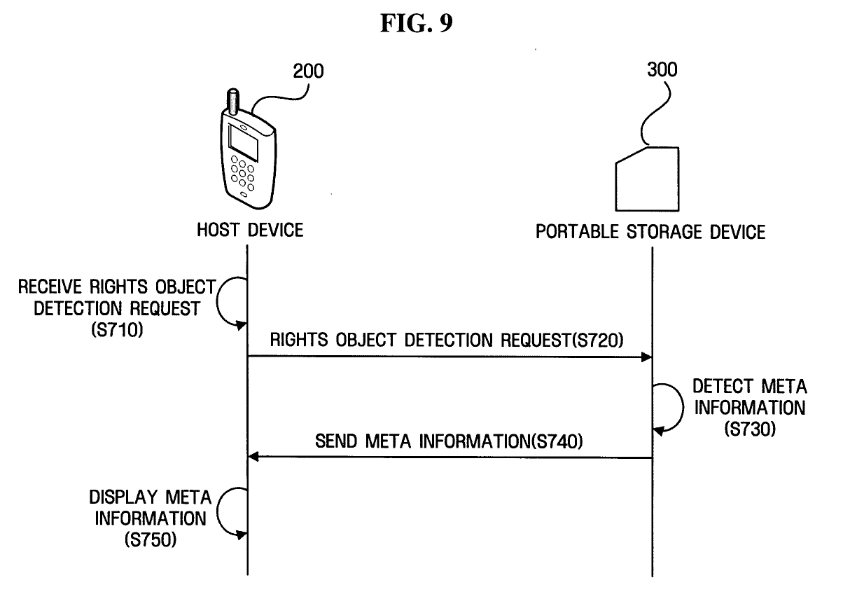

In an exemplary embodiment, the host device 200 may send a request for detection of an RO stored in the portable storage device 300, which will be described with reference to FIG. 9.

FIG. 9 is a flowchart illustrating a detection procedure, in which the host device 200 detects a rights object stored in the portable storage device 300, according to an exemplary embodiment of the present invention.

When the user input module 215 of the host device 200 receives an RO detection request from a user in operation S710, the control module 260 requests the portable storage device 300 to detect an RO through the device interface module 225. Here, the detection module 260 generates an RO detection request message and the device interface module 225 sends the generated RO detection request message S720 to the portable storage device 300.

If the device interface module 370 of the portable storage device 300 receives the RO detection request message from the host device 200, the detection module 320 detects meta information of ROs stored the portable storage device 300 in operation S730.

In operation S740, the control module 160 sends the detected meta information to host device 200 through the device interface module 370. Here, the portable storage device 300 may perform the steps S420 through S445 shown in FIG. 3 before offering the meta information to the host device 200. In this case, the time information necessary for performing the step S425 may be obtained from the host device 200.

Meanwhile, “offering the detected meta information to host device 200” means not only “the portable storage device 300 actively transmitting the meta information to the host device 200 through the device interface module 370” but also “granting the host device 200 access to the meta information”.

If the device interface module 225 of the host device 200 obtains the meta information from the portable storage device 300, the display module 245 displays the meta information in operation S750.

Here, if the user attempts to change the meta information of the RO stored in the portable storage device 300 through the user input module 215, changing of the meta information may be refused by an integrity check operation performed by the integrity check module 330 of the portable storage device 300.

As described above, the DRM device and method according to exemplary embodiments of the present invention can effectively detect information for rights objects.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. A digital rights management device comprising:
a storage module which stores a rights object having predetermined meta information;
a control module which provides meta information of rights objects stored in the storage module when a rights object detection request is input; and
an integrity check module which maintains integrity of the meta information.

2. The digital rights management device of claim 1, wherein the storage module stores a predetermined hash value of the meta information and the integrity check module calculates a hash value for the meta information provided by the control module using a predetermined hash function and makes the calculated hash value equalize the hash value stored in the storage module.

3. The digital rights management device of claim 1, wherein the meta information includes at least one of constraint information regarding consumption constraints of the rights object to play back a predetermined content object, permission information regarding play-back and reproduction types of the content object, and status information regarding usability of the rights object.

4. The digital rights management device of claim 3, wherein the status information of the rights object includes a valid state in which the rights object is usable, an invalid state in which the rights object is unusable, and an unidentified state in which usability of the rights object is not identifiable.

5. The digital rights management device of claim 4, further comprising a status information update module setting or changing the status information according to the constraint information and consumption of the rights object.

6. The digital rights management device of claim 5, wherein the integrity check module calculates a hash value for the meta information having the changed status information and updates a hash value pre-stored in the storage module with the calculated hash value.

7. The digital rights management device of claim 4, further comprising a status information update module, wherein when the status information is set in the unidentified state, the status information update module compares predetermined time information with constraint information to determine whether the rights object is usable or not, and if the rights object is determined as being in an unusable state, changing the status information of the rights object to an invalid state, wherein the integrity check module calculates a hash value for the meta information having the changed status information and updates a hash value pre-stored in the storage module with the calculated hash value.

8. A digital rights management method comprising:
providing meta information of rights objects stored in a predetermined storage medium when a rights object detection request is input; and
maintaining integrity of the meta information.

9. The digital rights management method of claim 8, wherein the storage medium stores a predetermined hash value of the meta information, and the maintaining of the integrity comprises calculating a hash value for the meta information using a predetermined hash function and making the calculated hash value equalize the hash value stored in the storage medium.

10. The digital rights management method of claim 8, wherein the meta information includes at least one of constraint information regarding consumption constraints of the rights object to play back a predetermined content object, permission information regarding play-back and reproduction types of the content object, and status information regarding usability of the rights object.

11. The digital rights management method of claim 10, wherein the status information of the rights object includes a valid state in which the rights object is usable, an invalid state in which the rights object is unusable, and an unidentified state in which usability of the rights object is not identifiable.

12. The digital rights management method of claim 11, further comprising updating the status information of the rights object by changing the status information according to the constraint information and consumption of the rights object.

13. The digital rights management method of claim 12, wherein the updating comprises:
calculating a hash value for the meta information having the changed status information; and
updating a hash value pre-stored in the storage medium with the calculated hash value.

14. The DRM method of claim 11, wherein when the status information is set in the unidentified state, the digital rights management method further comprises:
comparing predetermined time information with constraint information to determine whether the rights object is usable or not;
if the rights object is determined as being in an unusable state, changing the status information of the rights object to an invalid state;
calculating a hash value for the meta information having the changed status information; and
updating a hash value pre-stored in the storage medium with the calculated hash value.
